(19) United States
(12) Patent Application Publication
(10) Pub. No.: US 2017/0221514 A1
(43) Pub. Date: Aug. 3, 2017

(54) TAPE RECORDING MEDIUM

(71) Applicant: Panasonic Intellectual Property Management Co., Ltd., Osaka (JP)

(72) Inventors: KENYA HORI, Okayama (JP); TAKESHI MORITA, Hyogo (JP); HIROYUKI OTA, Osaka (JP); TATSUMASA YAMADA, Okayama (JP)

(21) Appl. No.: 15/292,241

(22) Filed: Oct. 13, 2016

(30) Foreign Application Priority Data
Jan. 28, 2016 (JP) 2016-014254
Jul. 19, 2016 (JP) 2016-141436

(51) Int. Cl. G11B 5/66; G11B 5/008

(52) U.S. Cl. CPC G11B 5/66; G11B 5/00813

(57) ABSTRACT

In a tape recording medium, a sliding layer has an electric resistance of 1×10⁸ Ω/sq or less, and contains carbon particles and solid particles. The carbon particles have a primary particle size of 30 nm or less and a BET specific surface area of 100 m²/g or more. The solid particles have a primary particle size of 100 nm or less, a Mohs' hardness in a range from 2.5 to 8, inclusive, a density of 3 g/cm³ or more, and a BET specific surface area of 30 m²/g or more.

### BACKGROUND

1. Technical Field

The present disclosure relates to a tape recording medium to be used as an audio tape, a video tape, or a data tape, for example.

2. Description of the Related Art

Examples of known tape recording media include magnetic recording tapes for magnetically recording and playing back data and optical recording tapes for optically recording and playing back data (signals). Independently of the recording type, a tape recording medium includes a recording layer (also called a recording and playback layer) in which information is recorded and from which the recorded information is read out. To enhance the recording density of the tape itself, the recording layer employs a minuter structure. A thinner tape recording medium has been demanded for increasing a recording capacity per a unit volume. In this manner, the entire length of the tape recording medium housed in a predetermined cartridge can be increased, for example.

Depending on, for example, the type of a tape recording medium and/or a recording and playback device using the tape recording medium, a surface of the tape recording medium provided with a recording layer slides on a fixed member such as a head or a stabilizer in the recording and playback device. In another case, a surface of the tape recording medium opposite to the surface provided with the recording layer slides on the fixed member. In general, in a magnetic recording medium, the surface of the magnetic recording medium provided with a recording layer slides only on a fixed member and a surface of the magnetic recording medium opposite to the surface provided with the recording layer slides on a rotatable member. On the other hand, in general, in any of media except the magnetic recording medium, a surface of the medium opposite to a surface of the medium provided with a recording layer slides only on a fixed member. For example, in a tape recording medium in which a recording layer has a minute structure that is broken when contacting a member in a recording and playback device, a surface of the tape recording medium opposite to a surface of the tape recording medium provided with the recording layer slides on a member in the recording and playback device. Such a tape recording medium, during recording or playback, moves in the recording and playback device while only the sliding surface makes contact with members including a fixed member in the recording and playback device.

In a conventionally proposed tape recording medium, a lubricating layer is provided on a surface provided with a recording layer, and a back coat layer containing carbon black as a main component is provided on a surface opposite to the surface provided with the recording layer. Another proposed tape-shaped optical recording medium has a structure in which a recording layer, a reflective layer, and an antistatic layer are stacked in this order over a principal surface of a polymer base. This optical recording medium plays back data (signals) by applying laser light to the recording layer through the polymer base.

### SUMMARY

The present disclosure has an object of providing a tape recording medium including a support, a recording layer disposed on a first principal surface of the support, and a sliding layer disposed on a second principal surface of the support. In this tape recording medium, running stability and running durability are enhanced, and generation of powder due to abrasion of the tape recording medium itself or a member in a recording and playback device is further suppressed. The tape recording medium will be hereinafter also simply referred to as a “recording medium” or “a medium.”

A tape recording medium according to the present disclosure includes a support, a recording layer disposed on a first principal surface of the support, and a sliding layer disposed on a second principal surface of the support. The sliding layer has an electric resistance of 1×10⁸ Ω/sq or less, and includes carbon particles and solid particles. The carbon particles have a primary particle size of 30 nm or less and a BET specific surface area of 100 m²/g or more. The solid particles have a primary particle size of 100 nm or less, a Mohs' hardness in a range from 2.5 to 8, inclusive, a density of 3 g/cm³ or more, and a BET specific surface area of 30 m²/g or more.

According to the present disclosure, since the sliding layer does not take charge easily, a tape recording medium can run more stably. In addition, according to the present disclosure, powder due to sliding of the sliding layer is not easily generated from, for example, the sliding layer or a fixed member in a recording and playback device. Thus, running durability can be higher. Furthermore, according to the present disclosure, degradation in the quality of a playback signal due attachment of powder and transfer of the shape of the powder to the medium does not easily occur, thus, durability in terms of signal quality can be higher.

### BRIEF DESCRIPTION OF DRAWINGS

FIG. 1 is a cross-sectional view schematically illustrating a tape recording medium according to an exemplary embodiment of the present disclosure;

FIG. 2 is a schematic view illustrating a method for measuring a Young's modulus of a sliding layer in a thickness direction thereof,

FIG. 3 is a graph showing a load-displacement curve when a force is applied to the sliding layer in the thickness direction;

FIG. 4 is a graph showing measurement results of Young's moduli of sliding layers obtained in Example 1-1 according to the exemplary embodiment of the present disclosure and Comparative Example 1-3; and

FIG. 5 is a schematic view illustrating a method for evaluating running durability of the sliding layer in the embodiment of the present disclosure.

### DETAILED DESCRIPTION OF PREFERRED EMBODIMENTS

Prior to description of an exemplary embodiment of the present disclosure, problems of conventional techniques will be described. As described above, in some types of recording media, the surface opposite to the surface provided with the recording layer needs to slide only on the fixed member. Thus, it is preferable to provide a durable sliding layer on a second principal surface of a support opposite to a first principal surface on which the recording layer is provided to obtain stability and durability during running. In structure, the sliding layer corresponds to a layer called a “back coat layer,” a “back coating layer,” or a “back layer” in conventional patent literatures. However, even when a structure of a back coat layer used in a conventional patent literature is applied to a sliding layer that slides on a fixed member of a recording and playback device, the resulting layer cannot endure sliding on the fixed member. In another case, generation of powder from the medium or a member in the recording and playback device due to abrasion cannot be sufficiently suppressed.

Specifically, Japanese Patent Unexamined Publication No. H5-73882 proposes a structure including a non-magnetic support, a magnetic layer, an intermediate layer provided between the non-magnetic support and the magnetic layer. The intermediate layer includes flat-shaped inorganic powder having an average diameter of 0.4 to 3.0 μm and acicular inorganic powder having an average major axis diameter of 0.05 to 0.5 μm. This patent literature also proposes a structure in which the intermediate layer is disposed between the non-magnetic support and a back coat layer. The flat-shaped inorganic powder has a plate ratio (average diameter/average thickness) of 5 to 150. This patent literature describes a paint containing carbon black, a nitrocellulose resin, a polyurethane resin, and a solvent, as a paint for the back coat layer. The back coat layer is formed by applying the paint onto the support and drying the coating.

Since the back coat layer includes conductive carbon black, the amount of static electricity generated in sliding on an insulator and in unwinding of a winded medium (separation electrification) can be reduced. Thus, the medium can run stably. However, the back coat layer including carbon black and a resin is fragile, and when the back coat layer slides on a relatively hard member such as a stabilizer or the like made of, for example, AlTiC, the back coat layer may be chipped under a force applied from, the stabilizer or the like to the back coat layer. When powder of chips of the back coat layer adheres to a recording surface of the recording medium, the quality of a recording and playback signal degrades. Furthermore, when the generated powder is mixed in a cartridge when the recording medium is wound and housed in a cartridge, the shape of the powder is transferred to the recording layer inside the cartridge. This transfer of the powder causes degradation in the quality of a recording and playback signal. In particular, in a case where the recording layer has a minute surface shape that affects recording and playback, the quality significantly degrades.

Each particle of the powder contained in the intermediate layer has a relatively large size. Thus, when the back coat layer is formed on the intermediate layer, the resulting back coat layer also has a relatively rough surface. If the surface of the back coat layer of the recording medium is rough, when the recording medium is wound, the shape of the surface of the back coat layer is transferred to a portion of the recording medium overlapping the back coat layer, and in some structures of the recording layer, the quality in a recording and playback signal degrades. In a case where the surface is rough because of the presence of coarse particles in the intermediate layer, the surface can be made flat to some degree by pressurization such as calendaring.

However, in a case where the surface of the recording layer has a minute shape, calendaring breaks this minute shape. Thus, planarization by calendaring cannot be applied to some structures of the recording layer. For this reason, the structure described in Japanese Patent Unexamined Publication No. H5-73882 cannot be employed in the case where the recording layer has a minute shape.

Japanese Patent Unexamined Publication No. H11-279443 proposes a non-magnetic paint that contains carbon black as a main component, a binder, an isocyanate hardener, and a polishing agent component having a Mohs' hardness of 6 or more, and can be obtained by dispersing them in an organic solvent with a moisture content of a predetermined value or less. This non-magnetic paint is used for forming a back coating layer of a magnetic recording medium. Specifically, this patent literature proposes α-alumina, zirconia and the like as the polishing agent component. The magnetic recording medium including the back coat layer is less likely to cause problems such as abrasion in a case where a surface at the back coat layer slides on a rotatable roller made of stainless steel or the like having a Mohs' hardness of about 4 to 5. However, in a case where the surface at the back coat layer slides on a member such as a stabilizer that is not rotatable but fixed, and is made of a hard material (e.g., AlTiC) having a Mohs' hardness of about 8, the member is abraded to generate powder. Such powder causes problems as described with reference to Japanese Patent Unexamined Publication No. H5-73882.

Japanese Patent Unexamined Publication No. 2004-241007 proposes a tape-shaped optical recording medium including a polymer support, a recording layer formed on a surface of the polymer support, and a back coat layer formed on the other surface of the polymer support. On the surface of the optical recording medium provided with the recording layer, a lubricant layer containing a specific compound is provided with a protective layer interposed therebetween. As an exemplary back coat layer, a layer containing carbon particles, barium ferrite, titanium oxide, and a polyurethane resin as a binder is described. The publication also describes that instead of or in addition to carbon particles, at least one type of particles selected from the group consisting of metal particles, metal oxide particles, and metal nitride particles may be used.

In the case of providing a lubricant layer as in the optical recording medium of Japanese Patent Unexamined Publication No. 2004-241007, the lubricant is transferred to the back coat layer when the recording medium is wound and housed. When separation electrification occurs while the surface of the back coat layer slides on a fixed member with the lubricant, which is an insulator in general and attached to the back coat layer, running stability degrades because of the electrification. Such separation electrification might also occur when the recording medium is unwound from a cartridge. The lubricant transferred to the back coat layer can also be transferred to a surface of the fixed member. If the lubricant transferred to the fixed member is accumulated, this lubricant becomes powder. When this powder is attached to a recording layer, if the medium is an optical recording medium, the powder becomes an optical pollutant and degrades the quality of a recording and playback signal. Of course, when powder derived from the lubricant is mixed together with the recording medium, a recording surface can be deformed, which might degrade the quality of a recording and playback signal. Since metal nitride particles are generally hard, in the case of using metal nitride particles instead of or in addition to carbon particles, a fixed member such as a stabilizer is easily abraded to generate powder. In addition, this patent literature does not mention the possibility that a surface roughness of the back coat layer affects the quality of a recording and playback signal.

Japanese Patent Unexamined Publication No. 2008-165841 proposes a tape-shaped optical recording medium that records and plays back information by applying laser light to a recording layer through a polymer base. This optical recording medium includes, in this order, the polymer base, the recording layer made of an optical recording material formed on a principal surface of the polymer base, a reflective layer, and an antistatic layer in which carbon black is dispersed in a resin. The antistatic layer has a center-line average surface roughness in a range from 3.0 to 15.0 nm and a surface electric resistance in a range from 1×10⁴ to 1×10⁸ Ω/sq. The antistatic layer may be supplemented with other inorganic fine powder in addition to carbon black, and various oxides are listed as the inorganic fine powder. Problems in a case where a layer that slides on a fixed member includes only carbon black as conductive particles are described in relation to Japanese Patent Unexamined Publication No. H5-73882. This patent literature does not describe a specific structure in the case of additionally using the inorganic fine powder. As described in relation to Japanese Patent Unexamined Publication No. H11-279443, with some types of inorganic fine powder, the fixed member might be abraded to produce powder, which can degrade the quality of a recording and playback signal.

In addition, in the optical recording medium of Japanese Patent Unexamined Publication No. 2008-165841, no layers are provided on one surface of the polymer base, and the surface of the polymer base itself constitutes a surface of the recording medium. Since the polymer base is an insulator, the polymer base is readily electrified, and powder within a recording and playback device easily adheres to the electrified surface. As described in relation to Japanese Patent Unexamined Publication No. H5-73882, such powder is likely to cause degradation in the quality of a recording and playback signal.

In a back coat layer of a magnetic recording medium proposed in Japanese Patent Unexamined Publication No. 2010-102818, neither structure nor secondary aggregate is substantially formed, and particles having an average primary particle size (D50) in a range from 0.05 to 1.0 μm are included. Particles including neither structure nor secondary aggregate are, for example, polymer particles having a crosslinked structure or inorganic fine particles of silicon dioxide, alumina, zirconia or the like. This back coat layer reduces recesses caused by bleed-through of the surface of a magnetic layer that causes a dropout, a decrease of an error rate, and a decrease of an S/N ratio. This patent literature proposes to add carbon black in order to make the back coat layer conductive.

Each type of particles specifically described as particles that form neither structure nor secondary agglomerate in Japanese Patent Unexamined Publication No. 2010-102818 has small conductivity. Thus, to avoid electrification, a considerable amount of carbon particles needs to be used. For example, in an example of this patent literature, 1.3 parts by weight of polymer particles are used with respect to 100 parts by weight of carbon black, that is, the proportion of carbon black is significantly high. As described in relation to Japanese Patent Unexamined Publication No. H5-73882, when such a back coat layer slides on a fixed member, the back coat layer is easily damaged. The patent literature also proposes the use of, for example, alumina and zirconia. Particles of these materials, however, have relatively high Mohs' hardness, and thus, the fixed member is easily abraded to generate powder, as described in relation to Japanese Patent Unexamined Publication No. H11-279443.

Japanese Patent Unexamined Publication No. 2005-183898 proposes a magnetic recording medium including a support, a magnetic layer disposed on the support and containing specific magnetic particles, and a back layer formed on the support at a side not provided with the magnetic layer. This patent literature also proposes formation of the back layer using inorganic fine powder together with carbon black. The patent literature further proposes the use of soft inorganic powder having a Mohs' hardness in a range from 3 to 4.5 together with hard inorganic powder having a Mohs' hardness in a range from 5 to 9, as the inorganic fine powder. However, materials described as examples of the soft inorganic powder and the hard inorganic powder have relatively high electric resistances, and when a large amount of such materials is added, the back layer is easily electrified. In a case where the hard inorganic powder has a large Mohs' hardness, a fixed member is abraded so that powder is easily generated.

As described above, the back coat layers and the antistatic layers described in the above-described six patent literatures are not designed as layers that slide on a fixed member made of a hard material. Thus, even if these techniques are applied without change to a recording medium of which a surface provided with a recording layer does not contact a member within a recording and playback device and only a surface opposite to the surface provided with the recording layer serves as a sliding surface, satisfactory characteristics cannot be obtained in terms of durability, antistatic properties, and prevention of powder generation. In particular, in a case where the recording medium is thin, running of the recording medium in the recording and playback device tends to be unstable because of electrification, and small rigidity of the recording medium causes the running to be more unstable. The surface provided with the recording layer is also referred to as a “recording surface”, and a surface opposite to the surface provided with the recording layer is also referred to as a “back surface” for convenience.

In a case where the recording layer has a minute structure that is used for recording and playback, if the back surface is rough, while the recording medium is wound and stored, the shape of the back surface is transferred to the recording surface so that the quality of a recording and playback signal degrades. To avoid this problem, the surface roughness of the back surface needs to be reduced so that the back surface is flat. As a flattening method, calendaring is known. The calendaring, however, has a problem of causing damage on the structure of the recording layer as described above, and cannot be employed.

To solve these problems, a recording medium in which only a back surface slides on a member including a stabilizer in a recording and playback device needs to have a sliding layer with a structure suitable for constituting the back surface. In an exemplary embodiment, specific carbon particles and specific solid particles are used to obtain a sliding layer that has high durability and antistatic properties and can reduce abrasion of the fixed member. Specifically, a material and an amount of the solid particles used together with the carbon particles are selected to achieve a specific Mohs' hardness and an electric resistance of 1×10⁸ Ω/sq or less in the entire sliding layer. Thus, the resulting recording medium has high durability and stability during running. In addition, in selecting solid particles in such a manner that an electric resistance of the entire sliding layer is the above-described value or less, the selection of a material and the amount of solid particles in such a manner that the entire sliding layer has a density of a specific value or more achieves higher strength and higher during durability of the sliding layer.

Hereinafter, an exemplary embodiment of the present disclosure will be specifically described with reference to the drawings. Unnecessarily detailed description may be omitted. For example, well-known techniques may not be described in detail, and substantially identical configurations may not be repeatedly described. This is because of the purposes of avoiding unnecessarily redundant description and easing the understanding of those skilled in the art.

The attached drawings and the following description are provided to enable those skilled in the art to fully understand the present disclosure. Therefore, the attached drawings and the following description are not intended to limit the subject matter recited in the claims.

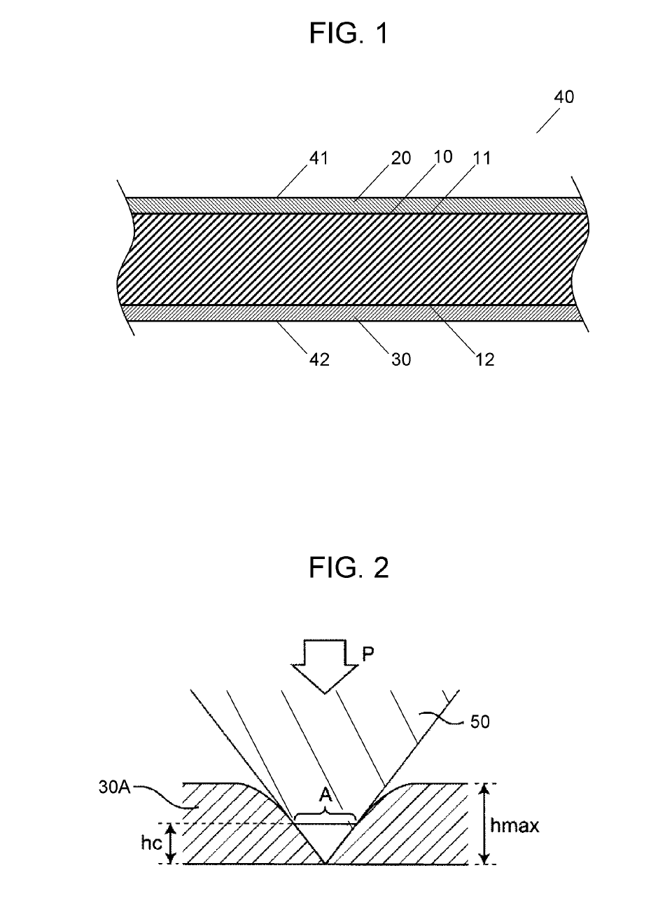

FIG. 1 schematically illustrates a cross section of tape recording medium (hereinafter referred to as recording medium) 40 according to an exemplary embodiment of the present disclosure. Recording medium 40 includes support 10, recording layer 20 disposed on first principal surface 11 of support 10, and sliding layer 30 disposed on second principal surface 12 at a back side of first principal surface 11. Sliding layer 30 has an electric resistance of 1×10⁸ Ω/sq or less, and contains carbon particles and solid particles. The carbon particles have a primary particle size of 30 nm or less and a BET specific surface area of 100 m²/g or more. The solid particles have a primary particle size of 100 nm or less, a Mohs' hardness in a range from 2.5 to 8, inclusive, a density of 3 g/cm³ or more, and a BET specific surface area of 30 m²/g or more. A surface of recording layer 20 constitutes recording surface 41, and a surface of sliding layer 30 constitutes back surface 42. In FIG. 1, support 10, recording layer 20, and sliding layer 30 are illustrated uniform and flat, but the present disclosure is not limited to this example.

With this configuration, even if the total thickness of recording medium 40 is small, recording medium 40 has high stability and durability during running in a recording and playback device, and generation of powder due to abrasion and attachment of the powder to recording surface 41 or back surface 42 can be suppressed. It is also possible to suppress transfer of the shape of the powder to recording surface 41. Since sliding layer 30 can be formed by coating, the cost for forming sliding layer 30 is lower than that for forming the layer with a vapor process.

Components constituting sliding layer 30 will now be described.

(Carbon Particles)

In this exemplary embodiment, the carbon particles having a primary particle size of 30 nm or less and a BET specific surface area of 100 m²/g or more are used.

If the primary particle size exceeds 30 nm, surface properties of sliding layer 30 degrade, and arithmetic average roughness Ra increases. When surface properties of sliding layer 30 degrade and the surface becomes rough, the surface shape of sliding layer 30 is easily transferred to recording surface 41 while recording medium 40 is wound and stored. In a case where recording layer 20 has a minute structure, such transfer of the shape degrades the quality of a recording and playback signal and causes an error. In this exemplary embodiment, in a case where calendaring cannot be performed for reasons such as the presence of a minute structure of recording layer 20, even if sliding layer 30 has a thickness of 0.5 μm or less, the primary particle size of carbon is set to 30 nm or less in order to obtain sufficient surface properties of sliding layer 30. The primary particle size of carbon may be, for example, 5 nm or more and 25 nm or less, may be 10 nm or more and 25 nm or less, and may be 10 nm or more and 20 nm or less.

The primary particle size refers to a particle size of particles that do not form an aggregate, and is measured with a dynamic light scattering particle size distribution analyzer in a state where the particles are dispersed in an appropriate solvent. In a case where carbon particles in sliding layer 30 has a particle size distribution, median particle size D50 is used as a primary particle size of the particles. Median particle size D50 corresponds to a particle size of 50 vol. % in cumulative distribution.

The BET specific surface area refers to a specific surface area obtained by a BET method, and is measured by using a nitrogen gas. If the carbon particles have a BET specific surface area less than 100 m²/g, adhesion between a resin serving as a binder and the carbon particles in sliding layer 30 decreases so that some of the carbon particles might be detached from sliding layer 30. When the detached carbon particles are attached to recording surface 41 of recording medium 40 or a recording and playback head of the recording and playback device, a signal quality in recording or playback degrades, which might cause an error. On the other hand, if the BET specific surface area is excessively large, in producing a paint for forming sliding layer 30, which will be described later, dispersibility of the carbon particles in the binder decreases so that production of the paint might be difficult. The upper limit of the BET specific surface area is, for example, 1000 m²/g. The BET specific surface area may be, for example, 100 m²/g or more and 500 m²/g or less, may be 100 m²/g or more and 400 m²/g or less, and may be 100 m²/g or more and 180 m²/g or less.

The type of the carbon particles is not specifically limited as long as the primary particle size and the BET specific surface area are within the above-described ranges, respectively. For example, carbon black such as furnace black for rubber, thermal black for rubber, black for color, or acetylene black may be used as the carbon particles. Two or more types of carbon particles formed of different materials, having different sizes, and/or specific surface areas may be used in combination.

(Solid Particles)

The solid particles used together with the carbon particles are used for reinforcing sliding layer 30, and reduce damage of sliding layer 30. The solid particles have a primary particle size of 100 nm or less, a Mohs' hardness of 2.5 or more and 8 or less, and a density of 3 g/cm³ or more, and a BET specific surface area of 30 m²/g or more.

As described in relation to the carbon particles, if the particle size of particles constituting sliding layer 30 is large, flatness of sliding layer 30 decreases, and thus, the primary particle size of the solid particles is also restricted. In this exemplary embodiment, the used solid particles has a primary particle size of 100 nm or less. The primary particle size of the solid particles may be, for example, 1 nm or more and 100 nm or less, and may be 5 nm or more and 50 nm or less. A method for measuring the primary particle size is similar to the method described for the carbon particles.

The primary particle size of the solid particles is preferably as small as possible. It should be noted that in a case where the solid particles are made of a metal other than gold and platinum, the solid particles having a small particle size might react with oxygen in the air to cause ignition. In another case, the solid particles having a small particle size might be oxidized by oxygen in the air to be an insulator. For this reason, in the case of using metal particles, the process may be performed in an environment purged with an inert gas when necessary. Alternatively, such metal particles may be coated with a material that is relatively stable in the air, such as carbon or gold.

The solid particles used in this exemplary embodiment have a Mohs' hardness of 2.5 or more and 8 or less. Sliding layer 30 of recording medium 40 slides on a fixed member made of a relatively hard material (e.g., AlTiC with a Mohs' hardness of 8). Thus, if the Mohs' hardness of the solid particles is substantially equal to or less than that of carbon, sliding layer 30 is easily damaged and abraded. Consequently, powder (abrasion powder) is easily generated. On the other hand, if the Mohs' hardness of solid particles is excessively high, the fixed member is abraded so that powder (abrasion powder) is easily generated from the fixed member. When the powder generated from any of sliding layer 30 and the fixed member is attached to recording surface 41 or back surface 42, the quality of a recording and playback signal can degrade, as described above. Therefore, in this exemplary embodiment, the Mohs' hardness of the solid particles is limited to the range described above so that abrasion resistance of sliding layer 30 is increased and abrasion of the fixed member is suppressed.

In a case where each of the solid particles is made of a plurality of materials, it is sufficient that the Mohs' hardness of the particles as a whole or the Mohs' hardness of a material constituting the surface of each of the solid particles is within the range described above. For example, solid particles obtained by causing alumina with a Mohs' hardness of about 9 to support (be mixed with) a soft metal such as platinum (with a Mohs' hardness of 8 or less) has a Mohs' hardness of 8 or less as a whole, and thus, can be used as the solid particles of this exemplary embodiment. Fine particles covered with aluminum hydroxide (e.g., NANOFINE produced by SAKAI CHEMICAL INDUSTRY CO., LTD.) can also be used as the solid particles in this exemplary embodiment.

The solid particles used in this exemplary embodiment have a density of 3 g/cm³ or more. The density herein refers to a true density (i.e., a density with a packing fraction of 100%). In this exemplary embodiment, the term simply noted by “density” refers to a true density. If the density is less than 3 g/cm³, the effect of increasing rigidity of recording medium 40 tends to decrease and running stability of recording medium 40 tends to decrease. Since the rigidity of recording medium 40 is proportional to the density thereof, the rigidity of recording medium 40 is preferably obtained by increasing the density of sliding layer 30 by using solid particles with a density larger than that of carbon particles. In addition, if the density is less than 3 g/cm³, in a case where solid particles need to be added to occupy 50 vol. % of a nonvolatile component of sliding layer 30, dispersion can be difficult in some cases.

The solid particles used in this embodiment have a BET specific surface area of 30 g/cm² or more. If solid particles have a BET specific surface area less than 30 m²/g, adhesion between the resin serving as a binder and the solid particles degrades so that some of the solid particles might be detached from sliding layer 30. When the detached solid particles are attached to recording surface 41 of recording medium 40 or a recording and playback head of the recording and playback device, a signal quality in recording or playback degrades, which might cause an error. The upper limit of the BET specific surface area of the solid particles is, for example, 500 m²/g. The BET specific surface area of the solid particles may be, for example, 30 m²/g or more and 500 m²/g or less, and may be 40 m²/g or more and 400 m²/g or less.

The solid particles preferably have an electric resistance of 1×10⁷ Ω/sq or less. When the electric resistance exceeds 1×10⁷ Ω/sq, the electric resistance of entire sliding layer 30 including an insulative binder such as a resin tends to increase. If the electric resistance of sliding layer 30 exceeds 1×10⁸ Ω/sq, recording medium 40 is easily electrified. For example, when recording medium 40 wound and housed in a cartridge is unwound and taken out, separation electrification occurs. When thin recording medium 40 having a total thickness less than 8 μm is electrified, running stability of recording medium 40 degrades. In addition, a pollutant (contamination) such as dust in the recording and playback device is easily attached to electrified recording medium 40. When recording medium 40 to which the pollutant is attached is wound and housed in the cartridge, the shape of the pollutant is transferred to recording surface 41 so that the quality of a recording and playback signal might degrade.

A material constituting the solid particles is not specifically limited as long as the material has a Mohs' hardness and a density in the ranges described above and has a BET specific surface area in the range described above in a particle state and the electric resistance in entire sliding layer 30 is 1×10⁸ Ω/sq or less. Examples of material constituting the solid particles will now be described.

(1) The solid particles may be made of a metal oxide. The metal oxide may be doped with a metal element. For example, the solid particles may be made of one of zinc oxide and tin oxide each doped with at least one metal element selected from the group consisting of antimony, gallium, aluminium, and indium. These materials preferably have electric resistances of 1×10⁷ Ω/sq or less. For example, conductive fine particles SN-100P produced by ISHIHARA SANGYO KAISHA, LTD. (tin oxide particles doped with antimony where powder pressed at 9.8 MPa has an electric resistance of 1 to 5 Ω/sq), for example, may be used as the solid particles.

(2) The solid particles may also be made of a metal (including an elemental metal and an alloy) or a ceramic. Examples of the metal include gold, platinum, copper, and an alloy of at least two of these metals. Examples of ceramic include SiC and AMC.

(3) The solid particles may be particles of an inorganic or organic substance coated with a metal (including an elemental metal and an alloy). Coating with the metal enables the particles having an electric resistance higher than 1×10⁷ Ω/sq and made of an inorganic substance such as oxide, nitride, or carbide or an organic substance such as polymer to be used as the solid particles.

As core particles to be coated with a metal, silica fine particles described in Japanese Patent Unexamined Publication No. 2008-285406, and carbon alloy fine particles doped with nitrogen atoms and fine particles obtained by causing such carbon alloy particles to support platinum both described in Japanese Patent Unexamined Publication No. 2007-311026, for example, can be preferably used. Alternatively, styrene-based hyper-branch polymers HPS-200 (with a diameter less than 10 nm) produced by Nissan Chemical Industries, Ltd., for example, may be used. As a method for coating the core particles, methods described in Japanese Patent Unexamined Publications Nos. 2007-197755 and 2007-321216 may be employed. For example, metal coating may be performed by a method of using a single component such as silica, titania, zinc oxide, and alumina or a complex thereof as the core particles and causing the core particles to react with a metal salt of an organic acid and an amine compound. Alternatively, metal coating may be performed by a method of placing the core particles in a solution containing a metal salt of an organic acid and an amine compound and causing a reducing agent to act in the solution.

Even in the case of using metal particles as the solid particles, if the metal particles have a high electric resistance, the metal particles may be coated with another metal having higher conductivity.

A metal coating may be formed by a general electroless nickel plating. In this case, solid particles coated with a metal or supporting a metal can also be obtained. In this case, electroless plating is performed with, for example, a bath including 0.1 mol/L of nickel sulfate, 0.3 mol/L of sodium hypophosphite, 0.1 mol/L of glycin, 0.1 mol/L of trisodium citrate, 2 mg/L of lead nitrate and having a pH of 5.5 at a bath temperature of 80° C.

(4) The solid particles may be particles of carbide. Specifically, SiC nanoparticles, and nanocarbide produced by a general plasma-arc welding method may be used as the solid particles. SiC nanoparticles produced by Sigma-Aldrich Co. LLC. may be used, for example. Alternatively, one of n-TiC and n-ZrC both produced by Hefei Kaier Nanometer Energy & Technology Co., Ltd., for example, may be used as the solid particles of carbide.

(5) The solid particles may be made of an inorganic substance coated with carbon. Such solid particles can have an electric resistance of 1×10⁷ Ω/sq or less. Specifically, Japanese Patent Unexamined Publication No. 2014-116249, for example, describes an inorganic substance coated with carbon, and such an inorganic substance can be preferably used. This patent literature also describes that conductive nanoparticles can be obtained by, for example, performing chemical vapor deposition on silicon nanoparticles (2 to 20 nm) in an organic gas of, for example, hydrocarbon such as methane. Japanese Patent Unexamined Publication No. 2011-240224 describes another inorganic substance coated with carbon. Such an inorganic substance can be formed in the following manner. First, using an organic substance such as a lignin compound having a high dispersibility and a high carbonization yield as a dispersant, an inorganic substance is dispersed together with this dispersant in a dispersion medium. Next, a general carbonization process (at 800 to 1200° C. in an inert atmosphere) is performed. Carbide particles obtained by this process are pulverized and classified. The thus-prepared particles may be used as the solid particles.

(6) The solid particles may be metal particles (including elemental metal particles and alloy particles) coated with carbon. As described above, metal particles having a nano-level particle size might cause ignition and oxidation, and thus, the carbon coating is provided to prevent these problems. Metal fine particles serving as a core may be any type of metal nanoparticles, or may be a nanometal particle cluster described in, for example, Japanese Patent Unexamined Publication No. 2004-052068. A carbon coating may be applied to these metal particles by a method described in, for example, Japanese Patent Unexamined Publication No. 2014-116249 described above. Specifically, conductive nanoparticles can be prepared by performing chemical vapor deposition in an organic gas of, for example, hydrocarbon such as methane. Alternatively, if the method described in Japanese Patent Unexamined Publication No. 2011-240224 described above is applied to metal nanoparticles instead of an inorganic substance, metal particles coated with carbon can be obtained.

(7) The solid particles may be carbon particles supporting a metal (including an elemental metal and an alloy) or a metal oxide. As such solid particles, platinum-supporting carbon black as described in, for example, Japanese Patent Unexamined Publication No. 2005-032668 may be used. A metal or a metal oxide supported on the carbon particles is selected from the group consisting of platinum, palladium, tin, ruthenium, cobalt, copper, nickel, cerium, and rhodium oxide. One or more types of metals or metal oxides may be supported. Alternatively, platinum-supporting carbon that is a catalyst for fuel cells provided as a product number 738557 by Sigma-Aldrich Co. LLC., for example, may be used as the solid particles.

(8) The solid particles may be Sb—SnO₂ particles supporting a metal (including an elemental metal and an alloy). The metal to be supported may be one of the metals that are exemplified in items (1) to (7) described above as those capable of constitute the solid particles. One or more types of metals may be supported. A supporting method is described in, for example, Electrochim Acta, 56, 2881 (2011). For example, particles obtained by causing Sb—SnO₂ (carrier or support) particles to support platinum may be used as the solid particles. Such solid particles can be prepared by causing tin oxide particles (carrier) in which antimony is solid-dissolved by replacement to support platinum nanoparticles in a highly dispersed state. Examples of the carrier include titanium nitride and titanium carbide, in addition to tin oxide. Platinum may be supported by using a flame method, an RF plasma method, or an electrification plasma baking method, for example.

(9) The solid particles may be ceramic particles supporting a metal (including an elemental metal and an alloy). A method for producing such solid particles is described in, for example, Japanese Patent Unexamined Publication No. 2015-147173, and particles produced by the method described in this publication may be used in this embodiment. In the solid particles, ceramic serving as a carrier or support may have a Mohs' hardness exceeding 8. As long as the solid particles supporting a metal has a Mohs' hardness of 8 or less, these solid particles can be used in this exemplary embodiment. Ceramic serving as a carrier may have an electric resistance exceeding 1×10⁷ Ω/sq.

The metal to be supported may be one of the metals that are exemplified in items (1) to (7) described above as those capable of constitute the solid particles. One or more types of metals may be supported. The type of the metal and the amount of the metal to be supported may be selected so that the electric resistance of sliding layer 30 is 1×10⁸ Ω/sq or less. Examples of solid particles obtained by causing ceramic to support a metal include platinum-alumina (Pt: 5%) code 168-13941 (with a density of 21.45 g/cm³) produced by Wako Pure Chemical Industries, Ltd.

The solid particles described above are examples, and other types of solid particles that are not described here may be used. A plurality of types of solid particles may be combined. For example, the solid particles described in item (1) and the solid particles described in item (4) may be combined to be use.

(Other Components Included in Sliding Layer)

In addition to the carbon particles and the solid particles, sliding layer 30 includes a binder for binding these particles and a dispersant for dispersing these particles. These components will now be described.

[Binder]

The binder constituting sliding layer 30 may be a hardening resin (including a thermosetting resin, a UV curable resin, and an electron beam curable resin) known as a resin for a paint or an adhesive resin, or a thermoplastic resin. Specifically, examples of the resin constituting the binder include a thermoplastic resin and a hardening resin. Examples of the thermoplastic resin include a polycarbonate resin, a polyamide resin, a polyphenylene oxide resin, a thermoplastic acrylic resin, a vinyl chloride resin, a fluorine resin, a vinyl acetate resin, and silicone rubber. Examples of the hardening resin include a urethane resin, a melamine resin, a silicon resin, a butyral resin, a reactive silicone resin, a phenol resin, an epoxy resin, an unsaturated polyester resin, a thermosetting acrylic resin, and a UV curable acrylic resin. Alternatively, the binder may be a copolymer in which two or more types of monomers are polymerized, or a denatured or modified substance of these resins. The binder may be used in combination with one or more types of additives selected from the group consisting of a dispersant and a levelling agent, for example, when necessary.

As will be described later, sliding layer 30 preferably has a true density of 1.640 g/cm³ or more. To satisfy this density, the binder may be suitably changed or a plurality of binders may be used. For example, to disperse the carbon and solid particles and to enhance adhesion to a support, the binder may have a large amount of pigment dispersion groups. Alternatively, the binder may show a high degree of adhesion to the support and have a large true density. These binders may be used solely or a plurality of types of these binders may be combined.

As a heavy binder, nitrocellulose (density: 1.66 g/cm³), for example, may be used together with a resin binder.

[Dispersant]

The dispersant is added in order to enhance dispersibility of the carbon particles and that of the solid particles. The dispersant may be a cationic dispersant, a nonionic dispersant, or an anionic dispersant. The cationic dispersant is, for example, FLOWLEN DOPA35 (density: 1.185 g/cm³) produced by KYOEISHA CHEMICAL CO., LTD. The nonionic dispersant is, for example, FLOWLEN D-90 produced by KYOEISHA CHEMICAL CO., LTD. The anionic dispersant is, for example, SN-SPERSE 2190 produced by SAN NOPCO Limited.

To set the true density of sliding layer 30 at 1.640 g/cm³ or more, a dispersant having a larger density may be used. Alternatively, in a case where the carbon particles and the solid particles are sufficiently dispersed and sliding layer 30 to be formed will have an Ra of 10 nm or less, sliding layer 30 may be formed without any dispersant. For example, the use of a binder having a high dispersing ability enables formation of sliding layer 30 using no dispersant.

[Other Components]

Sliding layer 30 may include an isocyanate agent in order to reduce viscidity derived from, for example, a hydroxy group included in the binder, the dispersant, or other components. The isocyanate agent undergoes an addition reaction with hydroxy groups (a hydroxy group except groups in contact with the support in the binder and a hydroxy group except a dispersion group of the dispersant) of the binder or the dispersant. The reactivity of the hydroxy groups used for the addition reaction is inversely proportional to a glass transition point of each of the binder and the dispersant, for example. To intentionally cause the addition reaction, a coating film may be formed by adding an isocyanate agent, and then followed by being heated.

Isocyanate agents can generate a carbon dioxide gas (with a weight of ≈0 g/cm³) through a condensation reaction, and this carbon dioxide gas can generate bubbles in the coating film in some cases. Thus, to obtain running durability by increasing the true density of sliding layer 30 as much as possible, the condensation reaction is preferably suppressed. For this reason, the additive amount of an isocyanate agent is preferably equal to or less than a proportion with which the hydroxy groups included in the binder or the dispersant and the isocyanate groups in the isocyanate agent cause chemical reaction at the same amount. For example, in the case of Vylon UR4800 used in examples below, the amount of the isocyanate agent may be 20 parts by weight (corresponding to the amount of a nonvolatile component) or less with respect to 100 parts by weight of the binder. In a case where the dispersant is FLOWLEN DOPA35 used in examples below, the amount of the isocyanate agent may be 100 parts by weight (corresponding to the amount of a nonvolatile component) or less with respect to 100 parts by weight of the dispersant. The additive amount of the isocyanate agent may have an upper limit lower than or higher than the upper limit described above, depending on the reactivity of the isocyanate agent and the number of hydroxy groups included in the binder and/or the dispersant, for example.

In a case where the viscidity derived from, for example, hydroxy groups in the binder and/or the dispersant does not adversely affect running stability, the isocyanate agent does not need to be used. The isocyanate agent easily undergoes an addition reaction with hydroxy groups or moisture. Thus, in the case of using particles showing strong catalyst action (e.g., a catalyst for fuel cells) as solid particles, reaction between the isocyanate agent and the binder and/or the dispersant in the state of a paint is accelerated by catalytic action of the solid particles. Consequently, the number (density) of hydroxy groups contributing to adhesion of sliding layer 30 to the support significantly decreases before start of coating so that adhesion might degrade. In this point of view, in a case where sliding layer 30 is formed by coating while the isocyanate agent and the solid particles showing catalytic action are used, reaction between the dispersant and/or the binder and the isocyanate agent in a paint state is preferably suppressed. To suppress the reaction, it is preferable that the isocyanate agent is added to a paint (a composition including, for example, a solvent in addition to the components described above) and the mixture is stirred immediately before coating (specifically within six hours at room temperature). In this case, it is more preferable that the isocyanate agent is added in an inert gas atmosphere having a low moisture content such as a nitrogen gas atmosphere.

(Sliding Layer)

The components included in sliding layer 30 have been described above. The following description is directed to proportions of the components included in sliding layer 30 and a preferable true density of sliding layer 30.

[Volume Fraction of Particles Including Carbon Particles and Solid Particles]

In a case where the solid particles are metal particles or inorganic or organic particles coated with a metal, the total volume of the carbon particles and the solid particles preferably occupies 20% or more of the volume of a nonvolatile component of sliding layer 30. In a case where the solid particles are neither metal particles nor inorganic or organic particles coated with a metal, the total volume of the carbon particles and the solid particles preferably occupies 50% or more of the volume of the nonvolatile component of sliding layer 30.

In a case where the solid particles are metal particles, and have high conductivity and a large density, addition of only a small amount of the solid particles causes sliding layer 30 to have low electric resistance and a large density. Consequently, resulting sliding layer 30 has excellent antistatic properties and high durability. Accordingly, desired sliding layer 30 can be obtained as long as the total volume of the carbon particles and the solid particles occupies at least 20% of the nonvolatile component. On the other hand, particles of a metal oxide or ceramic have a conductivity and a density smaller than those of a metal. Thus, in the case of using such particles as the solid particles, in order to make the electric resistance of sliding layer 30 to 1×10⁸ Ω/sq or less and a density of sliding layer 30 large, large amounts of the carbon particles and the solid particles are used so that the volume fraction of these particles occupies 50% or more of the nonvolatile component.

As the volume fraction of the carbon particles and the solid particles in the nonvolatile component of sliding layer 30 decreases, the surface roughness of sliding layer 30 tends to decrease.

[Proportion of Solid Particles]

In a case where the solid particles have an electric resistance of 1×10⁻⁶ Ω/sq or more, the proportion (the additive amount) of solid particles is preferably in a range from 1 to 60 vol. %, inclusive, where the proportion of total of the carbon particles and the solid particles is 100 vol. %. If the proportion of the solid particles made of a material having an electric resistance of 1×10⁻⁶ Ω/sq or more is less than 1 vol. %, the true density of sliding layer 30 is small, and running stability of the medium and durability of the sliding surface might be insufficient. On the other hand, the additive amount of the solid particles made of a material having an electric resistance of 1×10⁻⁶ Ω/sq or more is larger than 60 vol. %, the electric resistance of sliding layer 30 is high, and the surface is easily electrified. Consequently, fine particles in the recording and playback device or in the air are easily attached to recording medium 40, and the quality of a recording and playback signal might degrade. In a case where solid particles have an electric resistance of 1×10⁻⁶ Ω/sq or less, the proportion of the solid particles is preferably 1 vol. % or more where the proportion of total of the carbon particles and the solid particles is 100 vol. %.

[Electric Resistance]

In this exemplary embodiment, sliding layer 30 has an electric resistance of 1×10⁸ Ω/sq or less, and preferably 5×10⁷ Ω/sq or less. If the electric resistance of sliding layer 30 is higher than 1×10⁸ Ω/sq, recording medium 40 is easily electrified, and running becomes unstable. In addition, the electrification promotes attachment of dust in the recording and playback device to recording medium 40. As described above, the dust attached to recording medium 40 can cause degradation of the quality of a recording and playback signal. Thus, the proportion of the solid particles in the total mass or volume of the carbon particles and the solid particles and the proportion (volume fraction) of the total volume of the carbon particles and the solid particles in the nonvolatile component are selected in such a manner that resulting sliding layer 30 satisfies the range of the electric resistance described above. It should be noted that the values of the volume fraction and proportion of the solid particles described above are preferable examples.

[True Density]

It has been understood that there is a correlation between occurrence of damage or abrasion on the sliding layer due to sliding on a fixed member and a true density of the sliding layer. Specifically, it has been understood that if the sliding layer has a true density of 1.640 g/cm³ or more, the Young's modulus (reduced modulus “Er”) of the sliding layer in a thickness direction is 13 GPa or more, and damage or abrasion does not easily occur on the surface of the sliding layer. The Young's modulus in the thickness direction herein is a measured value of a hardness to a depth of 40 to 50 nm with respect to a thickness of 500 nm. The true density refers to a density defined on the assumption that the nonvolatile component of the sliding layer has a packing fraction of 100%, that is, the sliding layer is completely filled without a gap. In the case of forming a sliding layer by a method such as coating, it is impossible to form the sliding layer without a gap. Thus, the density of an actually formed sliding layer is not a true density but a bulk density (or an apparent density). However, if constituents of a sliding layer are known, a true density of the sliding layer can be obtained based on the density and proportion of the constituents.

In a case where the sliding layer has a true density of 1.640 g/cm³ or more, the sliding layer has a bulk density of about 1.310 g/cm³ or more.

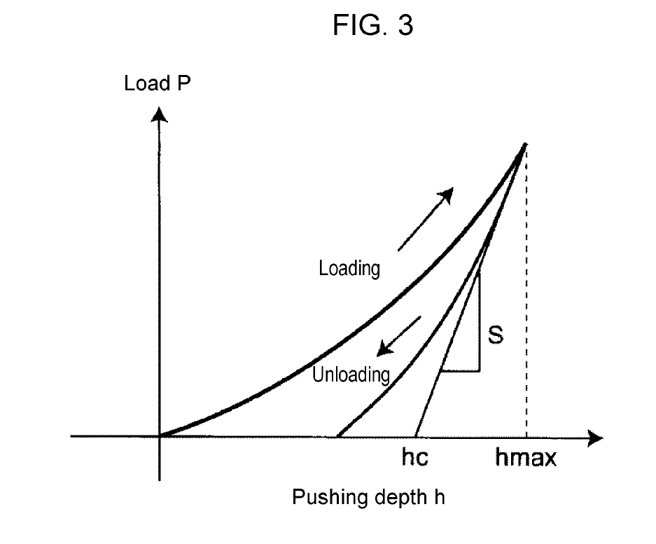

As schematically illustrated in FIG. 2, the Young's modulus of the sliding layer in the thickness direction can be obtained with Berkovich diamond indenter 50 using a Hysitron Triboscope that is an accessory of a scanning probe microscope JSPM4200 produced by JEOL Ltd. In this case, a load P is changed stepwise to 0.7 μN, 10 μN, and 50 μN, for example. First, contact depth hc is obtained from an unloading curve obtained by pushing indenter 50 to a depth (hmax) in sample 30A of a sliding layer and removing a load. Next, contact projected area A between indenter 50 and sample 30A and a composite Young's modulus of indenter 50 and sample 30A are obtained from contact depth hc. Furthermore, a Young's modulus of sample 30A is obtained. Contact depth hc is the value of an intersection point between a linear curve of stiffness S that is a slope of an unloading curve of a load-displacement (P-h) curve plotted in FIG. 3 and the horizontal axis. Contact depth hc is preferably about 1/10 of a thickness of sample 30A. The Young's modulus calculated based on such a contact depth is not affected by a base material. The contact projected area is cross sectional area A at contact depth hc. From an Oliver-Pharr method (O-P method), Equation 1 is obtained, and Equation 2 is obtained from a P-h curve. Young's modulus Er of each of the indenter and the sample is obtained from Equation 3.

A=24.5 hc² Equation 1

S=(2/√π)E*√A Equation 2

In Equation 2, S is a stiffness, and E* is a composite Young's modulus of indenter 50 and sample 30A.

1/E*=(1−v²)/Er+(1−vi²)/Ei Equation 3

In Equation 3, Er is a Young's modulus of sample 30A, Ei is a Young's modulus of indenter 50, v is a Poisson's ratio of sample 30A, and vi is a Poisson's ratio of indenter 50.

Thus, the types and mixture proportions of carbon particles, solid particles, and other nonvolatile components are preferably set in such a manner that sliding layer 30 has a true density of 1.640 g/cm³ or more. The true density of carbon particles used in examples below can be approximated to about 1.7 g/cm³, the true density of a nonvolatile component of the binder is about 1.34 g/cm³, and the true density of a nonvolatile component of the dispersant is about 1.185 g/cm³. In general, the densities of a resin and a nonvolatile component of the dispersant are smaller than the true densities of the carbon particles and the solid particles, although the densities differ among materials to some degree. Thus, in order to increase the true density of sliding layer 30, particles having a large true density are preferably used as the solid particles. To further increase the true density of sliding layer 30, the proportion of the total amount of the carbon particles and the solid particles in the nonvolatile component of sliding layer 30 may be increased.

(Method for Forming Sliding Layer)

In this exemplary embodiment, sliding layer 30 is formed by a method of dispersing or dissolving the carbon particles, the solid particles, the binder, the dispersant, and other components described above into a solvent, preparing a paint (a coating liquid), applying the paint onto a support, and drying the paint to evaporate the solvent. The solvent constituting the paint will now be described. A method for preparing the paint, a method for applying the paint onto the support, and the like will also be described.

[Solvent for Paint]

The solvent for the paint is specifically selected from, for example, the group consisting of water, toluene, cyclohexanone, isophorone, dimethyl sulfoxide, alcohols, esters, ethers, ketones, and alkyl cellosolves. Examples of the alcohols include methanol, ethanol, propanol, 2-propanol (IPA), butanol, diacetone alcohol, furfuryl alcohol, tetrahydrofurfuryl alcohol, methylene glycol, ethylene glycol, hexylene glycol, isopropyl glycol, tetrafluoro propanol, and octafluoro propanol. Examples of the esters include methyl acetate, ethyl acetate, and butyl acetate. Examples of the ethers include diethyl ether, ethylene glycol monomethyl ether, ethylene glycol monoethyl ether, ethylene glycol monobutyl ether, diethylene glycol monomethyl ether, diethylene glycol monoethyl ether, and propylene glycol monomethyl ether. Examples of the ketones include acetone, methyl ethyl ketone, methyl isobutyl ketone, acetylacetone, and acetoacetic ester. Examples of the alkyl cellosolves include methyl cellosolve, ethyl cellosolve, and butyl cellosolve. These solvents for the paint may be used solely, or a plurality of types of the solvents may be used in combination.

The density of sliding layer 30 formed on support 10 is not a true density but a bulk density, as described above. The packing fraction of sliding layer 30 can be enhanced by suitably selecting the solvent, concentrations of the nonvolatile component or a coating process, for example. For example, in order to reduce the amount of a solvent volatilized from sliding layer 30 after coating, cyclohexanone or a solvent having a volatility (a vapor pressure of 0.45 kPa or more at 20° C. or more) greater than or substantially equal to a volatility of cyclohexanone (a vapor pressure of 0.45 kPa at 20° C.), an SP value (7 to 10) substantially equal to that of cyclohexanone, and a coating property (a surface tension of 35 mN/m or less) substantially equal to that of cyclohexanone. Examples of the solvent having a volatility, an SP value, and coating property substantially equal to or greater than those of cyclohexanone include ketones, esters, hydrocarbons, alcohols, and ethers. Examples of the ketones include acetone, methyl ethyl ketone, methyl isobutyl ketone, and methyl propyl ketone. Examples of the esters include ethyl acetate and butyl acetate. Examples of the hydrocarbons include toluene and xylene. Examples of the alcohols include methanol, ethanol, and 2-propanol. Examples of the ethers include tetrahydrofuran. These solvents may be used solely, or a plurality of types of the solvents may be used in combination.

[Preparation of Paint]

The paint is prepared by dissolving or dispersing the carbon particles, the solid particles, the binder, the dispersant, and other components in a solvent. The carbon particles and the solid particles need to be dispersed in the paint, these particles are dispersed with a dispersing device. Specifically, examples of the dispersing device include known dispersing devices, mixing devices, and kneading devices, such as a mixer dispersing device, a kneading dispersing device, a medium-type dispersing device, a mediumless dispersing device, a bead mill dispersing device, a high-pressure dispersing device, a kneader device, and a stirring device.

In a case where a large amount of the carbon particles and the solid particles are loaded in order to increase the proportion of these particles in sliding layer 30, if the particles are insufficiently dispersed, the surface roughness of resulting sliding layer 30 increases. To avoid this problem, dispersing ability of the device is preferably increased. For example, the number of dispersing processes with the dispersing device is preferably increased.

Alternatively, the dispersing ability can be increased by suitably changing dispersing process conditions of the dispersing device. For example, in a bead mill dispersing device, in order to reduce thixotropy of a matrix (constituted by particles and a solvent or by particles, a solvent, and a dispersant) at wet-cracking of particles, a solvent having high permeability (wettability) and dispersibility (resin compatibility) is used. Alternatively, the amount of the solvent, the dispersant, or the additive amount of the dispersant may be adjusted. Alternatively, zirconia beads that are harder, heavier, and finer may be used. In the case of using a high-pressure dispersing device, dispersing ability can be changed by adjusting a pressure. Thus, the dispersing ability can be enhanced by increasing the pressure, for example. Since dispersing ability also varies depending on the type of the dispersing device. Thus, the use of a dispersing device for dispersion under high pressure instead of a dispersing device for dispersion under normal pressure can enhance dispersing quality of particles in the paint.

In preparing the paint, in order to eliminate or reduce agglomeration of the carbon particles or the solid particles in the paint, the paint before coating is not allowed to stand and is preferably stirred or circulated with an ultrasonic homogenizer or the like.

(Method for Forming Sliding Layer)

Sliding layer 30 may be applied onto the surface of support 10 by a known coating method such as a bar coating method, a spray coating method, a gravure coating method, a die coating method, and a reverse roll coating method. The thickness of the coating is adjusted in such a manner that a desired thickness can be obtained after evaporating a volatile solvent and solidifying or hardening a matrix precursor. As the concentration of a nonvolatile component included in the paint increases, the amount of a solvent that volatilizes after coating can be reduced, and the bulk density can be made closer to the true density. In some types of recording medium 40, a high-pressure process such as calendaring may be performed after the coating. The high-pressure process is effective for increasing the density of sliding layer 30.

(Thickness and Surface Roughness of Sliding Layer)

The thickness of sliding layer 30 is not specifically limited. However, the thickness of sliding layer 30 is adjusted so that recording medium 40 can be housed in the cartridge. For example, the thickness of sliding layer 30 may be 0.5 μm or less.

Sliding layer 30 preferably has a surface flatness having an arithmetic average roughness Ra of 10 nm or less. If Ra exceeds 10 nm, the shape of surface roughness (unevenness) of sliding layer 30 housed in the cartridge is transferred to the recording surface so that the quality of a recording and playback signal degrades.

(Other Elements)

Other elements constituting recording medium 40 may be elements used in a tape-shaped magnetic recording medium and/or a tape-shaped optical recording medium.

[Support]

Support 10 is a film or a sheet of a polymer (resin). Examples of the polymer include polyester-based polymers such as polyethylene terephthalate and polyethylene naphthalate, cellulose-based polymers, polycarbonate-based polymers, and acrylic polymers. These resins may be used solely, or two or more types of such resins may be used together. The support may be a layered structure. In order to enhance adhesion with sliding layer 30 or other functional layers, an adhesive layer may be provided on the support. A material constituting the adhesive layer is not specifically limited.

[Recording Layer]

In a case where recording medium 40 is a medium for optical recording and playback, a minute groove for recording and playback is formed in a surface of support 10 on which recording layer 20 is to be formed before sliding layer 30 is formed. The minute groove may be formed by an existing technique. For example, the groove may be formed by a nano-imprint technique. In the nano-imprint technique, while a groove-formed surface of a stamper in which a fine groove is formed is pressed against a surface of the support, a resin material between the support and the groove-formed surface of the stamper is subjected to hardening or plastic deformation so that the shape of the minute groove is transferred to the surface of the support. A reflective layer, a dielectric layer, a phase change layer, and a dielectric layer (each not shown) are stacked in this order on the surface having the groove so that optical recording and playback can be performed. The reflective layer is made of a metal such as aluminium, silver, or a silver alloy having a high reflection factor with respect to a laser wavelength for recording and playback. The dielectric layer controls heat and light before and after a phase change of the recording layer or during the phase change, and is made of at least one compound selected from the group consisting of an oxide, a nitride, and a sulfide. The recording layer is made of a material that can cause a phase change (change in reflection factor) upon application of light, such as GeSbTe.

In the case of using recording medium 40 as a medium for magnetic recording and playback, recording layer 20 may be a known recording layer used for, for example, an audio tape, a video tape, or a data tape. The recording layer for magnetic recording may be formed by a known technique using a known material. For example, in the case of an evaporation-type magnetic recording medium, recording layer 20 of, for example, cobalt oxide is formed by evaporation. Next, a protective layer (not shown) of diamond-like carbon (DLC) is formed by chemical vapor deposition (CVD) over a surface of recording layer 20. Then, a lubricant layer of, for example, a fluorine compound is formed by coating or the like on the surface of the protective layer. In this manner, these layers may be formed. In the case of a coating-type magnetic recording medium, in addition to a magnetic material such as iron oxide and barium ferrite, one or more types of materials selected from materials described below are added to the binder, and these materials are mixed, thereby preparing a paint.

alumina or the like as a hard additive for enhancing durability of the magnetic layer;

fatty acid or the like as a lubrication additive; and

carbon or the like as an antistatic material for preventing electrostatic destruction of a recording and playback head.

After applying this paint, calendaring or the like is performed, thereby forming recording layer 20. Recording layer 20 may be a single layer, or may have a laminated structure.

Recording layer 20 of the magnetic recording medium may be formed to have a small thickness and a minute structure in order to enhance a recording density. Alternatively, a portion except the outermost surface layer (sliding layer 30) opposite to the surface provided with recording layer 20 of the magnetic recording medium may be formed with a combination of an evaporation-type and coating-type techniques and materials thereof.

Recording medium 40 is slit to have a predetermined width depending on a recording method, application and the like, and is processed to have a length corresponding to a predetermined recording capacity and housed in a predetermined cartridge.

### EXAMPLES

The present disclosure will be more specifically described referring examples below, but is not limited only to these examples. In the examples, surface electric resistances and running durability of each of sliding layers with various compositions are evaluated. For the evaluation, samples in each of which a sliding layer is formed on a surface of a support are prepared, and no recording layers are formed. The types of recording and playback of the tape recording medium according to the embodiment is not limited to a magnetic type, and may be an optical or magneto-optical type.

(Contents of Carbon Particles and Solid Particles)

In the examples, first, a blank sliding layer (Comparative Example 1-3) including 30 parts by weight of carbon particles and none of solid particles is prepared. Then, a part of the carbon particles included in the sliding layer is replaced by solid particles, and changes in antistatic properties and running durability of the sliding layer depending on the presence of the solid particles are evaluated.

For example, in Example 1-1, antimony-doped tin oxide (SN-100P with a true density of 6.6 g/cm³ produced by ISHIHARA SANGYO KAISHA, LTD.) is used as the solid particles. In Examples 1, the solid particles in an amount corresponding to 5.5 vol. % of 100 vol. % of the carbon particles constituting 30 parts by weight of the blank sliding layer, that is, 5.5 vol. % of carbon is added. Thus, the proportion (content) of the carbon particles is 28.35 parts by weight (=30 parts by weight×94.5 wt. %), and the proportion of the solid particles is 6.4 parts by weight. The proportion of the solid particles is determined by calculation as (30−28.35)× (true density of the antimony-doped tin oxide/true density of the carbon particles).

In a case where the additive amount of the antimony-doped tin oxide is 60 vol. %, the proportion of the carbon particles is 12 parts by weight (=30 parts by weight×40 wt. %), and the proportion of the solid particles is 69.88 parts by weight (=(30−12)× (true density of the antimony-doped tin oxide/true density of the carbon particles)).

In a case where the content of the solid particles is determined with this method, if the solid particles are made of a material except a metal (including an alloy), that is, a material having an electric resistance of 1×10⁻⁶ Ω/sq or more, the proportion of the solid particles is preferably 1 vol. % carbon or more and 60 vol. % carbon or less. The proportion indicated by “vol. % carbon” is a proportion in a case where 30 parts by weight of carbon particles are 100 vol. % carbon. In this range, when the solid particles made of a material having an electric resistance of 1×10⁻⁶ Ω/sq or more are added, a sliding layer having excellent antistatic properties and high running durability can be obtained. If the proportion of the solid particles made of a material having an electric resistance of 1×10⁻⁶ Ω/sq or more is less than 1 vol. % carbon, the true density of the sliding layer is less than 1.640 g/cm³, and running stability of the medium and durability of a sliding surface are insufficient. On the other hand, if the additive amount of solid particles made of a material having an electric resistance of 1×10⁻⁶ Ω/sq or more is larger than 60 vol. % carbon, the electric resistance of the sliding layer is high, and the surface is easily electrified. Consequently, fine particles in the recording and playback device or in the air are easily attached to the recording medium so that the quality of a recording and playback signal might degrade.

In a case where the solid particles are made of a metal such as platinum or gold or an alloy such as Nichrome and have an electric resistance of 1×10⁻⁶ Ω/sq or less, the proportion of solid particles is preferably 1 vol. % carbon or more. In this case, if the content of solid particles is less than 1 vol. % carbon, even if the true density of the sliding layer is 1.640 g/cm³ or more, the surface electric resistance of the sliding layer exceeds 5×10⁷ Ω/sq. Thus, sufficient antistatic properties cannot be obtained. However, in the case of the solid particles made of aluminium (having a true density of 2.7 g/cm³ and a Mohs' hardness of 2.4), even if the true density of the sliding layer is 1.640 g/cm³ or more, running durability of the medium is low. This is because of a low true density and a small Mohs' hardness of aluminium.

Samples produced in examples will be described below.

### Examples 1: Metal Oxide Particles

### Example 1-1

A paint with the following composition is prepared.

carbon particles: #1000 produced by Mitsubishi Chemical Corporation with a primary particle size of 18 nm, a true density of 1.6 g/cm³ or more and 1.8 g/cm³ or less (1.7 g/cm³ in average), a BET specific surface area of 180 m²/g, and a content of 28.35 parts by weight (94.5 vol. % carbon).

antimony-doped tin oxide particles as solid particles: SN-100P produced by ISHIHARA SANGYO KAISHA, LTD. with a true density of 6.6 g/cm³ and a content of 6.4 parts by weight (5.5 vol. % carbon).

binder: Vylon UR4800 produced by TOYOBO CO., LTD. with a true density of a nonvolatile component of 1.34 g/cm³ and a content of 13.7 parts by weight.

dispersant: FLOWLEN DOPA35 produced by KYOEISHA CHEMICAL CO., LTD with a true density of a nonvolatile component of 1.185 g/cm³ and a content of 7.09 parts by weight (=25 wt. % of carbon particles).

methyl ethyl ketone as a solvent: 108.6 parts by weight (including solvents of a binder and the like)

toluene as a solvent: 26.25 parts by weight (including solvents of a binder and the like)

cyclohexanone as a solvent: 2.127 parts by weight (including solvents of a binder and the like)

methyl isobutyl ketone as a solvent: 45 parts by weight

With this composition, the true density of the sliding layer is 1.641 g/cm³.

The paint with the composition described above is wetted, cracked, and dispersed with a pressure kneader, a ball grinder, or a high-pressure mill, for example. The thus-prepared dispersion solution is diluted in a solvent mixture in which a weight ratio among methyl ethyl ketone toluene methyl isobutyl ketone is 20.79:58.54:20.68 so that a concentration of a nonvolatile component is 14%, thereby preparing a paint for a sliding layer. The paint has a viscosity of 0.005±0.005 Pa·s at 25° C. Before applying this paint, an isocyanate agent (Coronate 3041 produced by Tosoh Corporation) is added while stirring with a Disper so that the proportion of a nonvolatile component of the isocyanate agent is 3 parts by weight. Then, this paint is applied onto a surface of a support (polyethylene naphthalate film produced by TEIJIN LIMITED and having a film thickness of 4.5 μm), the solvent is evaporated, and the isocyanate agent and the like are hardened, thereby producing a sliding layer adjusted to have a thickness of 0.4 μm±0.1 μm.

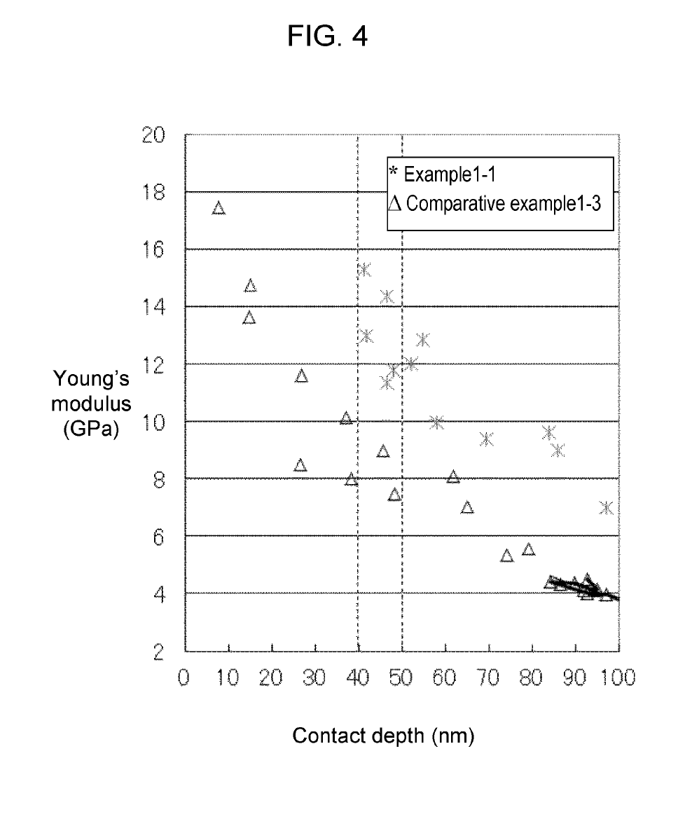

It is evaluated that the obtained sliding layer has an electric resistance of 9×10⁶ Ω/sq. It is also evaluated that the sliding layer has a Young's modulus (reduced modulus “Er”) of 13 GPa in the thickness direction. As described above, this Young's modulus is an average value of Young's moduli with contact depths of 40 to 50 nm with respect to a thickness of 500 nm. FIG. 4 shows measurement results.

### Example 1-2

A paint with the following composition is prepared.

carbon particles are the same as those used in Example 1-1 and a content thereof is 12 parts by weight (40 vol. % carbon).

solid particles are the same as those used in Example 1-1 and a content thereof is 69.88 parts by weight (60 vol. % carbon).

binder is the same as that used in Example 1-1 and a content thereof is 13.7 parts by weight.

dispersant is the same as that used in Example 1-1 and a content thereof is 3 parts by weight (25 wt. % of carbon particles).

methyl ethyl ketone: 108.6 parts by weight (including solvents of a binder and the like)

toluene: 26.25 parts by weight (including solvents of a binder and the like)

cyclohexanone: 2.127 parts by weight (including solvents of a binder and the like)

methyl isobutyl ketone: 45 parts by weight

With this composition, the true density of the sliding layer is 5.108 g/cm³.

Using this paint, a sliding layer is formed in a manner similar to that in Example 1-1.

### Examples 2: Ceramic Particles

### Example 2-1

A paint with the following composition is prepared.

carbon particles are the same as those used in Example 1-1 and a content thereof is 25.02 parts by weight (83.4 vol. % carbon).

SiC particles as solid particles: nanoparticles 594911 produced by Sigma-Aldrich Co. LLC. with a true density of 3.22 g/cm³ and a content of 9.433 parts by weight (15.5 vol. % carbon).

binder is the same as that used in Example 1-1 and a content thereof is 13.7 parts by weight.

dispersant is the same as that used in Example 1-1 and a content thereof is 6.255 parts by weight (25 wt. % of carbon particles).

methyl ethyl ketone: 108.6 parts by weight (including solvents of a binder and the like)

toluene: 26.25 parts by weight (including solvents of a binder and the like)

cyclohexanone: 2.127 parts by weight (including solvents of a binder and the like)

methyl isobutyl ketone: 45 parts by weight

With this composition, the true density of the sliding layer is 1.641 g/cm³.

Using this paint, a sliding layer is formed in a manner similar to that in Example 1-1.

### Example 2-2

A paint with the following composition is prepared.

carbon particles are the same as those used in Example 1-1 and a content thereof is 12 parts by weight (40 vol. % carbon).

solid particles are the same as those used in Example 2-1 and a content thereof is 34.094 parts by weight (60 vol. % carbon).

binder is the same as that used in Example 1-1 and a content thereof is 13.7 parts by weight.

dispersant is the same as that used in Example 1-1 and a content thereof is 3 parts by weight (25 wt. % of carbon particles).

methyl ethyl ketone: 108.6 parts by weight (including solvents of a binder and the like)

toluene: 26.25 parts by weight (including solvents of a binder and the like)

cyclohexanone: 2.127 parts by weight (including solvents of a binder and the like)

methyl isobutyl ketone: 45 parts by weight

With this composition, the true density of the sliding layer is 2.422 g/cm³.

Using this paint, a sliding layer is formed in a manner similar to that in Example 1-1.

### Examples 3: Metal Particles

### Example 3-1

A paint with the following composition is prepared.

carbon particles are the same as those used in Example 1-1 and a content thereof is 29.6 parts by weight (98.6 vol. % carbon).

platinum particles as solid particles: product name PtDA produced by TANAKA KIKINZOKU KOGYO K.K. with a true density of 21.5 g/cm³ and a content of 5.312 parts by weight (1.4 vol. % carbon).

binder is the same as that used in Example 1-1 and a content thereof is 13.7 parts by weight.

dispersant is the same as that used in Example 1-1 and a content thereof is 7.393 parts by weight (25 wt. % of carbon particles).

methyl ethyl ketone: 108.6 parts by weight (including solvents of a binder and the like)

toluene: 26.25 parts by weight (including solvents of a binder and the like)

cyclohexanone: 2.127 parts by weight (including solvents of a binder and the like)

methyl isobutyl ketone: 45 parts by weight

With this composition, the true density of the sliding layer is 1.641 g/cm³.

Using this paint, a sliding layer is formed in a manner similar to that in Example 1-1.

### Example 3-2

A paint with the following composition is prepared.

carbon particles are the same as those used in Example 1-1 and a content thereof is 12 parts by weight (40 vol. % carbon).

solid particles are the same as those used in Example 3-1 and a content thereof is 30 parts by weight (8.1 vol. % carbon).

binder is the same as that used in Example 1-1 and a content thereof is 13.7 parts by weight.

dispersant is the same as that used in Example 1-1 and a content thereof is 3 parts by weight (25 wt. % of carbon particles).

methyl ethyl ketone: 108.6 parts by weight (including solvents of a binder and the like)

toluene: 26.25 parts by weight (including solvents of a binder and the like)

cyclohexanone: 2.127 parts by weight (including solvents of a binder and the like)

methyl isobutyl ketone: 45 parts by weight

With this composition, the true density of the sliding layer is 2.763 g/cm³.

Using this paint, a sliding layer is formed in a manner similar to that in Example 1-1.

In each of Examples 3, since larger weight parts of platinum particles having higher conductivity are blended, even in a case where the total volume (48.1 vol. % carbon) of the particles is smaller than those in other examples (100 vol. % carbon in total), an excellent sliding layer is obtained.

### Reference Example 3-3

As solid particles, 54 parts by weight of the same platinum particles as those used in Example 3-1 are used, and no carbon particles are used, thereby preparing a paint in a manner similar to that in Example 1. The content of the solid particles corresponds to 20.1 vol. % carbon where 30 parts by weight of carbon particles are 100 vol. % carbon. With this composition, the true density of the sliding layer is 5.291 g/cm³. Using this paint, a sliding layer is formed in a manner similar to that in Example 1-1.

### Example 4: Metal Particles

A paint with the following composition is prepared.

carbon particles are the same as those used in Example 1-1 and a content thereof is 29.46 parts by weight (98.2 vol. % carbon).

gold particles as solid particles: nanoparticles 741973 produced by Sigma-Aldrich Co. LLC. with a Mohs' hardness of 2.5, a true density of 17.3 g/cm³, and a content of 5.498 parts by weight (1.8 vol. % carbon).

binder is the same as that used in Example 1-1 and a content thereof is 13.7 parts by weight.

dispersant is the same as that used in Example 1-1 and a content thereof is 7.365 parts by weight (25 wt. % of carbon particles).

methyl ethyl ketone: 108.6 parts by weight (including solvents of a binder and the like)

toluene: 26.25 parts by weight (including solvents of a binder and the like)

cyclohexanone: 2.127 parts by weight (including solvents of a binder and the like)

methyl isobutyl ketone: 45 parts by weight

With this composition, the true density of the sliding layer is 1.644 g/cm³.

Using this paint, a sliding layer is formed in a manner similar to that in Example 1-1.

### Example 5: Platinum-Alumina Particles

A paint with the following composition is prepared.

carbon particles are the same as those used in Example 1-1 and a content thereof is 29.58 parts by weight (98.6 vol. % carbon).

particles in which platinum is supported on alumina, as solid particles: platinum alumina 168-13941 produced by Wako Pure Chemical Industries, Ltd. with a true density of 21.45 g/cm³ and a content of 5.299 parts by weight (1.4 vol. % carbon).

binder is the same as that used in Example 1-1 and a content thereof is 13.7 parts by weight.

dispersant is the same as that used in Example 1-1 and a content thereof is 7.395 parts by weight (25 wt. % of carbon particles).

methyl ethyl ketone: 108.6 parts by weight (including solvents of a binder and the like)

toluene: 26.25 parts by weight (including solvents of a binder and the like)

cyclohexanone: 2.127 parts by weight (including solvents of a binder and the like)

methyl isobutyl ketone: 45 parts by weight

With this composition, the true density of the sliding layer is 1.641 g/cm³.

Using this paint, a sliding layer is formed in a manner similar to that in Example 1-1.

### Comparative Examples 1-1 to 1-3

As solid particles, the same antimony tin oxide particles as those used in Examples 1 are used in Comparative Example 1-1, and the same SiC particles as those used in Examples 2 are used in Comparative Example 1-2. In Comparative Example 1-3, only carbon particles are used, none of solid particles are added, and a blank sliding layer is formed.

In each of the comparative examples, the content of the carbon particles (#1000 produced by Mitsubishi Chemical Corporation) is 29.73 parts by weight. The content of the solid particles is 1.048 parts by weight in Comparative Example 1-1, and 0.511 parts by weight in Comparative Example 1-2. In each of the comparative examples, a dispersant (FLOWLEN DOPA35 produced by KYOEISHA CHEMICAL CO., LTD) is added in such a manner that the content of a nonvolatile component thereof is 7.4325 parts by weight. In Comparative Examples 1-1 and 1-2, the content of the dispersant corresponds to 25 wt. % of the carbon particles. In Comparative Example 1-3, the content of the dispersant corresponds to 25 wt. % of 29.73 parts by weight of the carbon particles. The contents of the other components are the same as those in Example 1-1, and a paint of each of the comparative examples is prepared in a manner similar to that in Example 1-1, and using this paint, a sliding layer is prepared.

The true density of the sliding layer is 1.630 g/cm³ in Comparative Example 1-1, 1.545 g/cm³ in Comparative Example 1-2, and 1.529 g/cm³ in Comparative Example 1-3. It is evaluated that a Young's modulus (reduced modulus “Er”) of the sliding layer in the thickness direction in each comparative example with respect to a thickness of 500 nm is 12 GPa in Comparative Example 1-1, 10 GPa in Comparative Example 1-2, and 10 GPa or less in Comparative Example 1-3. Each of these values of the samples is an average value of Young's moduli with contact depths of 40 to 50 nm with respect to a thickness of 500 nm. FIG. 4 shows measurement results of Comparative Example 1-3.

### Comparative Examples 2

As the solid particles, the same antimony tin oxide as those used in Example 1 are used in Comparative Example 2-1, and the same SiC particles as those used in Example 2 are used in Comparative Example 2-2.

In each of the comparative examples, the content of the carbon particles (#1000 produced by Mitsubishi Chemical Corporation) is 11.7 parts by weight (39 vol. % carbon). The content of the solid particles is 71.047 parts by weight (61 vol. % carbon) in Comparative Example 2-1, and 34.662 parts by weight (61 vol. % carbon) in Comparative Example 2-2. In each of the comparative examples, a dispersant (FLOWLEN DOPA35 produced by KYOEISHA CHEMICAL CO., LTD) is added in such a manner that the content of a nonvolatile component thereof is 2.925 parts by weight (25 wt. % of carbon particles). The contents of the other components are the same as those in Example 1-1, and a paint of each of the comparative examples is prepared in a manner similar to that in Example 1-1. Using this paint, a sliding layer is formed. The true density of the sliding layer is 5.139 g/cm³ in Comparative Example 2-1 and 2.434 g/cm³ in Comparative Example 2-2.

### Comparative Example 3

Aluminium particles (#5 produced by HORI METAL LEAF & POWDER CO., LTD. with a true density of 2.7 and a Mohs' hardness of 2.4) having a Mohs' hardness less than 2.5 are used as the solid particles. In Comparative Example 3, the content of the carbon particles (#1000 produced by Mitsubishi Chemical Corporation) is 26.4 parts by weight (88 vol. % carbon), the content of the solid particles is 5.718 parts by weight (12 vol. % carbon), and the content of a nonvolatile component of the dispersant (FLOWLEN DOPA35 produced by KYOEISHA CHEMICAL CO., LTD) is 6.6 parts by weight (25 wt. % of carbon particles). The contents of the other components are the same as those in Example 1-1, and a paint is prepared in a manner similar to that in Example 1-1. Using this paint, a sliding layer is formed. The true density of the sliding layer is 1.650 g/cm³.

### Comparative Example 4

Alumina particles (nanoparticles 544833 produced by Sigma-Aldrich Co. LLC. with a density of 4.0 g/cm³ and a Mohs' hardness of 9), which are metal oxide particles each having a Mohs' hardness greater than 8, are used as the solid particles. In Comparative Example 4, the content of the carbon particles (#1000 produced by Mitsubishi Chemical Corporation) is 28.95 parts by weight (96.5 vol. % carbon), the content of the solid particles is 2.464 parts by weight (3.5 vol. % carbon), the content of a nonvolatile component of the dispersant (FLOWLEN DOPA35 produced by KYOEISHA CHEMICAL CO., LTD) is 7.365 parts by weight (25 wt. % of carbon particles). The contents of the other components are the same as those in Example 1-1, and a paint is prepared in a manner similar to that in Example 1-1. Using this paint, a sliding layer is formed. The true density of the sliding layer is 1.642 g/cm³.

The sliding layers of the thus-prepared tape samples are subjected to the following evaluation.

Arithmetic Average Roughness Ra [Nm] of Sliding Layer Surface

Arithmetic average roughness Ra of a surface of the sliding layer at 30 μm sq is measured with an AFM surface roughness meter produced by SHIMADZU CORPORATION.

(Surface Electric Resistance)

An electric resistance of a surface of the sliding layer is measured with a circuit tester.

(Running Durability)

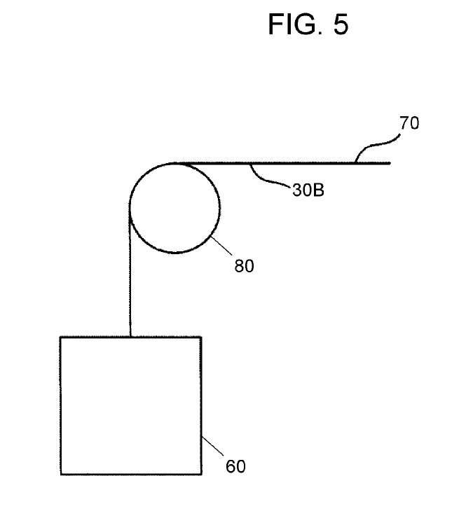

As schematically illustrated in FIG. 5, tape sample 70 and fixing pin 80 are disposed in such a manner that sliding surface 30B of tape sample 70 provided with weight 60 forms 90 degrees at fixing pin 80. Fixing pin 80 is made of an AlTiC material (with an R3.5 and an Rmax of 70 nm) with a diameter of 7 mm produced by KYOCERA Corporation and had a Mohs' hardness of 8. While maintaining this positional relationship, reciprocation sliding running is performed 100 times at 10 mm/sec. A surface of sliding surface 30B and a surface of fixing pin 80 are observed visually and with an optical microscope of 100 magnifications before and after the running, thereby evaluating running durability of sliding surface 30B. Specifically, the presence or absence of damage and abrasion of sliding surface 30B, the presence or absence of occurrence of abrasion powder from sliding surface 30B, the presence or absence of damage and abrasion of a surface of fixing pin 80, and the presence or absence of occurrence of abrasion powder from a surface of fixing pin 80 are observed.

Running durability is evaluated based on the following evaluation standards.

GD: No damage is observed on sliding surface 30B and a surface of fixing pin 80, and no abrasion powder is generated.
OK: Occurrence of slight damage is observed on sliding surface 30B, and generation of a small degree of abrasion powder from sliding surface 30B is observed.
NG: Damage is observed on sliding surface 30B, and a large amount of abrasion powder is generated from sliding surface 30B.
BD: Small or no damage is observed on sliding surface 30B, but damage is observed on the surface of fixing pin 80 and generation of abrasion powder from the surface of fixing pin 80 is observed.

Table 1 shows the primary particle size, the electric resistance, the Mohs' hardness, and the BET specific surface area of each kind of the solid particles used in the examples and the comparative examples and the evaluation results on each of the sliding layers in the examples and the comparative examples.

TABLE 1

| | Solid Particle | | | | | | | | Carbon | | | | |
|---|---|---|---|---|---|---|---|---|---|---|---|---|---|
| | | | | | | | BET | | Particle | Sliding Layer | | | |
| | | Primary | | | | | specific | Additive | Additive | Arithmetic | | | |
| | | particle | Electric | | True | | surface | amount | amount | average | True | Electric | |
| | | size | resistance | | density | Moh's | area | (parts by | (parts by | roughness | density | resistance | Running |
| | Material | (nm) | (Ω/sq) | | (g/cm³) | hardness | (m²/g) | weight) | weight) | Ra(nm) | (g/cm³) | (Ω/sq) | durability |
| Example 1-1 | Sb-doped | 20 | 1-5 | | 6.6 | 7 | 65-80 | 6.4 | 28.4 | ≦10 | 1.641 | ≦5 × 10⁷ | GD |
| | SnO₂ | | | | | | | | | | | | |
| Example 1-2 | Sb-doped | 20 | 1-5 | | 6.6 | 7 | 65-80 | 69.9 | 12.0 | ≦10 | 5.108 | ≦5 × 10⁷ | GD |
| | SnO₂ | | | | | | | | | | | | |
| Example 2-1 | SiC | <100 | 1 × | 10⁵⁻⁶ | 3.2 | ≦8 | 70-90 | 9.4 | 25.0 | ≦10 | 1.641 | ≦5 × 10⁷ | GD |
| Example 2-2 | SiC | <100 | 1 × | 10⁵⁻⁶ | 3.2 | ≦8 | 70-90 | 34.1 | 12.0 | ≦10 | 2.422 | ≦5 × 10⁷ | GD |
| Example 3-1 | Pt | 2 | 1 × | 10⁻⁷ | 21.5 | 4-4.5 | >30 | 5.3 | 29.6 | ≦10 | 1.641 | ≦5 × 10⁷ | GD |
| Example 3-2 | Pt | 2 | 1 × | 10⁻⁷ | 21.5 | 4-4.5 | >30 | 30.0 | 12.0 | ≦10 | 2.763 | ≦5 × 10⁷ | GD |
| Reference | Pt | 2 | 1 × | 10⁻⁷ | 21.5 | 4-4.5 | >30 | 54.0 | 0 | ≦10 | 5.291 | ≦5 × 10⁷ | GD |
| Example 3-3 | | | | | | | | | | | | | |
| Example 4 | Au | 30 | 1 × | 10⁻⁷ | 17.3 | 2.5 | >30 | 5.5 | 29.5 | ≦10 | 1.644 | ≦5 × 10⁷ | GD |
| Example 5 | Pt—Al₂O₃ | 60 | 1 × | 10⁶ | 21.5 | ≦8 | >60 | 5.3 | 29.6 | ≦10 | 1.641 | ≦5 × 10⁷ | GD |
| Comparative | Sb-doped | 20 | 1-5 | | 6.6 | 7 | 65-80 | 1.0 | 29.7 | ≦10 | 1.630 | ≦5 × 10⁷ | OK to GD |
| Example 1-1 | SnO₂ | | | | | | | | | | | | |
| Comparative | SiC | <100 | 1 × | 10⁵⁻⁶ | 3.2 | ≦8 | 70-90 | 0.5 | 29.7 | ≦10 | 1.545 | ≦5 × 10⁷ | NG to OK |
| Example 1-2 | | | | | | | | | | | | | |
| Comparative | — | — | — | | — | — | — | — | 30.0 | ≦10 | 1.529 | ≦5 × 10⁷ | NG |
| Example 1-3 | | | | | | | | | | | | | |
| Comparative | Sb-doped | 20 | 1-5 | | 6.6 | 7 | 65-80 | 71.0 | 11.7 | ≦10 | 5.139 | >1 × 10⁸ | GD |
| Example 2-1 | SnO₂ | | | | | | | | | | | | |
| Comparative | SiC | <100 | 1 × | 10⁵⁻⁶ | 3.2 | ≦8 | 70-90 | 34.7 | 11.7 | ≦10 | 2.434 | >1 × 10⁸ | GD |
| Example 2-2 | | | | | | | | | | | | | |
| Comparative | Al | <100 | 1 × | 10⁻⁷ | 2.7 | 2.4 | 30 | 5.7 | 26.4 | ≦10 | 1.650 | ≦5 × 10⁷ | NG to OK |
| Example 3 | | | | | | | | | | | | | |
| Comparative | Al₂O₃ | <50 | 1 × | 10¹⁴≦ | 4.0 | 9 | >40 | 2.5 | 29.0 | ≦10 | 1.642 | ≦5 × 10⁷ | BD |
| Example 4 | | | | | | | | | | | | | |

As clearly shown in Table 1, each of the examples shows an electric resistance of 5×10⁷ Ω/sq or less and high running durability. On the other hand, the comparative examples have problems in at least one item. Each of Comparative Examples 1-1 and 1-2 shows a smaller content of the solid particles than those of Examples 1-1 and 2-1. Thus, the true density is small, and sliding surface 30B is easily damaged so that running durability degrades. In contrast, each of Comparative Examples 2-1 and 2-2 shows a content of the solid particles larger than those of Examples 1-2 and 2-2. Thus, the electric resistances of Comparative Examples 2-1 and 2-2 exceed 1×10⁸ Ω/sq. Such a high electric resistance allows the sliding layer to be easily electrified. In Comparative Example 3, aluminium having a low Mohs' hardness is used as the solid particles. Thus, sliding surface 30B is easily damaged, and running durability degrades. On the other hand, in Comparative Example 4, alumina particles having a high Mohs' hardness are used as the solid particles. Thus, sliding surface 30B has a high hardness, and fixing pin 80 is easily damaged so that running durability degrades.

A tape recording medium according to the present disclosure is applicable as a recording medium that slides on a relatively hard fixed member in recording and playback. Specifically, a tape recording medium according to the present disclosure can be used as an audio tape, a video tape, a data tape, or the like.

What is claimed is:

1. A tape recording medium comprising:
a support;
a recording layer disposed on a first principal surface of the support; and
a sliding layer disposed on a second principal surface of the support,
wherein the sliding layer has an electric resistance of 1×10⁸ Ω/sq or less, and includes:
carbon particles having a primary particle size of 30 nm or less and a BET specific surface area of 100 m²/g or more; and
solid particles having a primary particle size of 100 nm or less, a Mohs' hardness in a range from 2.5 to 8, inclusive, a density of 3 g/cm³ or more, and a BET specific surface area of 30 m²/g or more.

2. The tape recording medium according to claim 1,
wherein the sliding layer has a Young's modulus of 13 GPa or more in a thickness direction of the sliding layer.

3. The tape recording medium according to claim 1,
wherein the sliding layer has a true density of 1.640 g/cm³ or more.

4. The tape recording medium according to claim 1,
wherein the sliding layer has an electric resistance of 5×10⁷ Ω/sq or less.

5. The tape recording medium according to claim 1,
wherein the solid particles are at least one type of particles selected from the group consisting of:
particles of a metal oxide;
particles of an elemental metal or an alloy;
ceramic particles;
inorganic or organic particles each coated with an elemental metal or an alloy,
particles of a carbide,
inorganic particles coated with carbon,
particles of an elemental metal or an alloy each coated with carbon, and
carbon particles supporting an elemental metal, an alloy, or a metal oxide.

6. The tape recording medium according to claim 5,
wherein the solid particles include inorganic particles supporting the elemental metal or the alloy, and
the inorganic particles supporting the elemental metal or the alloy are at least one type of particles selected from the group consisting of:
Sb—SnO₂ particles supporting an elemental metal or an alloy and
ceramic particles supporting an elemental metal or an alloy.

7. The tape recording medium according to claim 5,
wherein the solid particles include particles of the metal oxide, and
the particles of the metal oxide are doped with a metal element.

8. The tape recording medium according to claim 7,
wherein the metal element is at least one element selected from the group consisting of antimony, gallium, aluminum, and indium, and
the metal oxide is zinc oxide or tin oxide.

9. The tape recording medium according to claim 7,
wherein the metal element is antimony, and
the metal oxide is tin oxide.

10. The tape recording medium according to claim 1,
wherein a surface of the sliding layer has an arithmetic average roughness Ra of 10 nm or less.
